(19) United States
(12) Patent Application Publication
(10) Pub. No.: US 2020/0009902 A1
(43) Pub. Date: Jan. 9, 2020

(54) SYSTEM AND METHOD FOR PRODUCING PIXELATED MODELING COMPOUND ARTWORK

(71) Applicant: CRAYOLA LLC, EASTON, PA (US)

(72) Inventors: Margaret Katherine Brogan, Downingtown, PA (US); Michael G. Moskal, Pottstown, PA (US); Leena Vadaketh, Doylestown, PA (US)

(21) Appl. No.: 16/458,472

(22) Filed: Jul. 1, 2019

Related U.S. Application Data
(60) Provisional application No. 62/694,655, filed on Jul. 6, 2018.

(51) Int. Cl. B44C 3/04; B28B 7/00

(52) U.S. Cl. CPC B44C 3/046; B28B 7/0029

(57) ABSTRACT

A system, kit, device, and method for generating pixelated modeling compound art is provided. The system or kit can include a modeling tool, a substrate, a plurality of modeling compounds, and optionally a leveler. The modeling tool may include one or more characteristics identifying specific distinct cells or portions of cells of the modeling tool that are associated with a specific modeling compound having a distinct characteristic, e.g., a color. The specified modeling compound may be pressed or inserted into apertures in the cells to provide a plurality of individual volumes of modeling compound deposited on the substrate. The modeling tool may be removed, leaving the pixelated modeling compound art present on the substrate.

### CROSS-REFERENCE TO RELATED APPLICATIONS

This application claims priority to U.S. Provisional Application No. 62/694,655, filed on Jul. 6, 2018, the disclosure of which is incorporated by reference in its entirety, for all purposes, herein.

### TECHNICAL FIELD

Aspects herein describe a system, kit, device, and methods for forming pixelated modeling compound artwork.

### BACKGROUND

Traditionally, a user may utilize one or more modeling compounds to form an intended design by free-forming individual modeling compound pieces, which may then be further assembled or arranged to form an intended design. However, the free-form nature of the user assembling or arranging the individual pieces of modeling compound makes it difficult to form an intended design with uniform spacing and size for at least a portion of the individual pieces of modeling compound present in the final design.

### DESCRIPTION OF THE DRAWINGS

Illustrative aspects are described in detail below with reference to the attached drawing figures, and wherein:

FIG. 1 is perspective view of a system for forming pixelated modeling compound artwork, specifically showing a modeling tool, a substrate, a plurality of modeling compounds, and an optional leveler, in accordance with aspects herein;

FIG. 2A is a perspective view of a modeling tool having a plurality of cells, in accordance with aspects herein;

FIG. 2B is a close up view of one cell of the modeling tool of FIG. 2A;

FIG. 3 is a top view of a first surface of an example modeling tool, in accordance with aspects herein;

FIG. 4 is a top view of a second surface of the example modeling tool of FIG. 3, in accordance with aspects herein;

FIG. 5A is a top view of an example modeling tool positioned on top of a substrate, with a portion of the cells of the modeling tool being populated with modeling compound according to the characteristics present on the first surface of the modeling tool, in accordance with aspects herein;

FIG. 5B is a cross-sectional view of a portion of cells populated with the modeling compound as depicted in FIG. 5A, in accordance with aspects herein;

FIG. 5C is a cross-sectional view of a portion of cells populated with the modeling compound as depicted in FIG. 5A after having the excess modeling compound removed, in accordance with aspects herein;

FIG. 6A is a top view of a substrate with a completed pixelated modeling compound artwork piece thereon, specifically showing the deposited volumes of modeling compound positioned according to the characteristics of the modeling tool first surface and depicting the intended design, in accordance with aspects herein; and

FIG. 6B is a cross-sectional view of a portion of the deposited volumes of modeling compound on the substrate as depicted in FIG. 6A, in accordance with aspects herein.

### DETAILED DESCRIPTION

Aspects herein are described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In brief and at a high level, this disclosure describes, among other things, a system, kit, device, and method for generating pixelated modeling compound artwork. In aspects, a system or kit is provided that can include a modeling tool, a substrate, a plurality of modeling compounds, and optionally a leveler. In aspects, the modeling tool can include one or more characteristics that are associated with specific modeling compounds. In certain aspects, the one or more characteristics can include a coloration on a surface of the modeling tool, or various markings, including imprints, words, numbers, and the like on the surface of the modeling tool. In certain aspects, the one or more characteristics on the modeling tool may identify specific distinct cells or portions of cells of the modeling tool, for depositing specific modeling compounds having a distinct characteristic, e.g., a color, into the apertures of the cells to form an intended design.

In some aspects, as discussed above, the pixelated modeling compound artwork can be generated using a modeling tool as a template onto which modeling compound corresponding to the intended design is pressed into apertures of specific modeling tool cells. A substrate may be layered below the modeling tool, such that deposited volumes of modeling compound embedded within the cells of the modeling tool may come into contact with the surrounding modeling tool material forming the cell and the substrate. In some aspects, excess modeling compound can optionally be removed from the surface of the modeling tool by scraping with a leveler. The modeling tool may then be removed from the substrate, leaving a plurality of individual deposited volumes of modeling compound “pixels” arranged in an intended design. It should be understood, that the terms pixels and pixelated is not limiting to the shape of the individual deposited volumes of modeling compound, but rather is described herein to apply to any shape or design provided by the cells of the modeling tools described herein.

In one aspect, a kit for generating pixelated modeling compound artwork is provided. The kit can include a modeling tool having a first surface and an opposing second surface. The modeling tool can include a plurality of cells, each of the plurality of cells having an aperture extending from the first surface to the second surface. The plurality of cells can exhibit a plurality of characteristics. The kit can also include a plurality of modeling compounds. Each of the plurality of modeling compounds can be separable into a plurality of segments.

In another aspect, a pixelated modeling compound artwork system is provided. The system can include a modeling tool having a first surface and an opposing second surface. The modeling tool can include a plurality of cells, each of the plurality of cells having an aperture extending from the first surface to the second surface. A first portion of the plurality of cells can exhibit a first cell characteristic on the first surface, and a second portion of the plurality of cells can exhibit a second cell characteristic on the first surface. The system can also include a first modeling compound having a first modeling compound characteristic corresponding to the first cell characteristic and a second modeling compound having a second modeling compound characteristic corresponding to the second cell characteristic. The system can also include a substrate that includes a modeling surface having an area Aₛ, where the first surface of the modeling tool has an area Aₘ, and where the area Aₛ is equal to or greater than the area Aₘ. The substrate and the modeling tool can be cooperatively adapted to receive on the modeling surface a plurality of deposited volumes of the first and second modeling compounds to form an intended design, and each of the plurality of deposited volumes can correspond to individual cells of the plurality of cells.

In yet another aspect, a pixelated modeling compound artwork device is provided. The device can include a modeling tool having a first surface and an opposing second surface. The modeling tool can include a plurality of cells, where each of the plurality of cells has an aperture extending from the first surface to the second surface, and where the plurality of cells exhibit a plurality of characteristics. The device can also include a substrate having a modeling surface having an area Aₛ, where the first surface of the modeling tool has an area Aₘ, wherein the area Aₛ is equal to or greater than the area Aₘ. The device can further include a plurality of modeling compounds, each of the plurality of modeling compounds separable into a plurality of segments. The modeling tool and the substrate can be adapted to be shifted from: 1) a modeling configuration where the modeling tool is positioned on the substrate so that the second surface of the modeling tool contacts the modeling surface of the substrate; and 2) a display configuration where the modeling tool is removed from the substrate so that the second surface of the modeling tool no longer contacts the modeling surface of the substrate.

In aspects, a method for producing pixelated modeling compound artwork is provided. The method for producing pixelated modeling compound artwork may include providing or receiving a kit and/or system having a plurality of different modeling compounds and a modeling tool. In aspects, the plurality of different modeling compounds can include modeling compounds having distinct characteristics, such as distinct colors, that can correspond to one or more distinct characteristics on the modeling tool. In aspects as discussed herein, the distinct characteristics on the modeling tool may identify specific distinct cells or portions of cells of the modeling tool, where a modeling compound having a distinct characteristic, e.g., a color, is to be inserted into an aperture of that cell. The kit and/or system may further include a substrate for using as a backing to the artwork and receiver of the inserted modeling compound, as well as a leveler for removal of excess modeling compound from the surface of the modeling tool.

In some aspects, a user may position the modeling tool on top of the substrate. In such aspects, the user may begin pressing segments of modeling compound into the apertures of the modeling tool cells, using the one or more characteristics on the modeling tool as a guide/template for which distinct modeling compound to utilize. For example, a modeling tool may include an image of a rainbow, with the cells of the modeling tool tinted (or otherwise marked) to identify where on the modeling tool the different colors of the rainbow reside. The user may then insert the corresponding colored modeling compound for each patterned element on the modeling tool, into the specific apertures of the cells tinted, colored, or marked on the modeling tool. For example, a user may take multiple segments of red modeling compound and insert it into the apertures of the cells of the modeling tool wherever the modeling tool or portion of cells is colored red or otherwise marked, such that the red modeling compound segments contact the substrate surface and the surrounding cell or modeling tool material. Further, a user may take an orange modeling compound and insert segments of the modeling compound into the apertures of the cells of the modeling tool wherever the modeling tool or portion of cells is colored orange or otherwise marked. As such, the modeling tool may surround the inserted segment of orange modeling compound, and the portion of the substrate residing directly beneath that particular orange-colored cell element is in contact with a deposited volume of modeling compound or “pixel” of modeling compound defined by the boundaries of the cell and the substrate on which the modeling compound is positioned.

A user may continue to apply segments of varying colored modeling compounds to the corresponding cells on the modeling tool, thereby depositing the varying colors of modeling compound within the aperture formed from the cell. Once the desired amount of artwork is created, such as a user “pixelating” the entire modeling tool with its corresponding modeling compound segments, a leveler may optionally be used to remove excess modeling compound from the upper surface of the modeling tool. Finally, a user may carefully remove the modeling tool away from the substrate, leaving individual deposited volumes of modeling compound or pixels arranged in the ornamental design adhered to or contacting to the substrate.

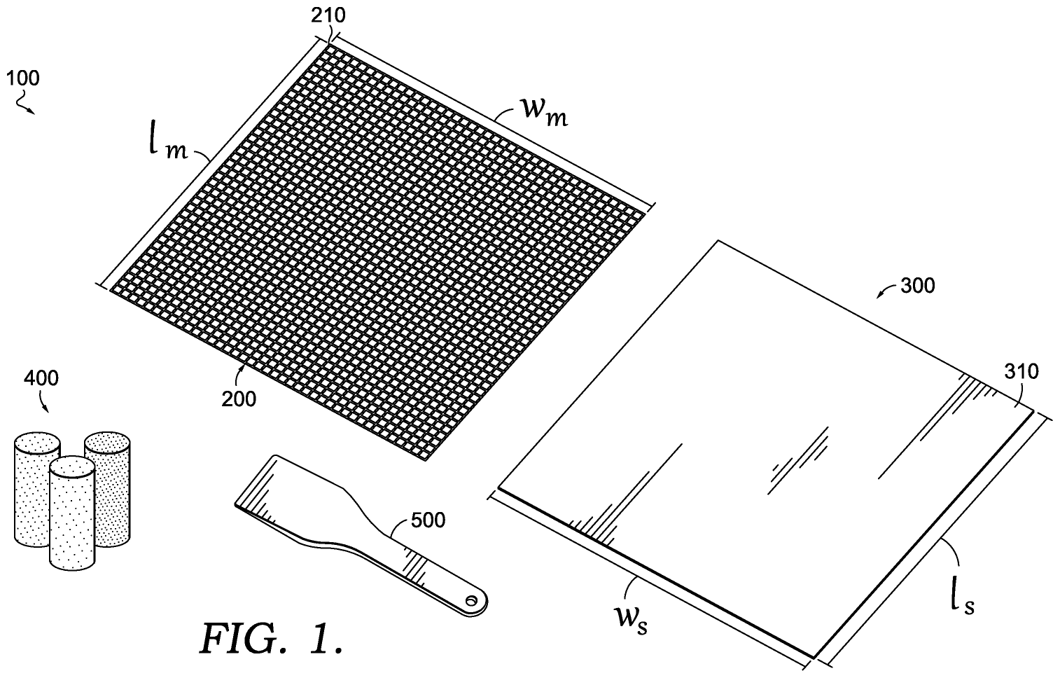

Turning now to the figures, and FIG. 1 in particular, a system 100 for generating pixelated modeling compound artwork is depicted. It should be understood that the system 100 described herein is just one example system for generating pixelated modeling compound artwork and that modifications to the system 100 or its components are contemplated by the present disclosure. In the aspect depicted in FIG. 1, the system 100 can include a modeling tool 200, a substrate 300, and a plurality of modeling compounds 400. In the same or alternative aspects, the system 100 may optionally include a leveler 500.

In aspects, the plurality of modeling compounds 400 can include any convenient clay-based materials, dough-based materials, synthetic materials, or a combination thereof. In one aspect, the plurality of modeling compounds 400 can include a plurality of different colored modeling compounds, such as Crayola® Model Magic® or Crayola® Dough.

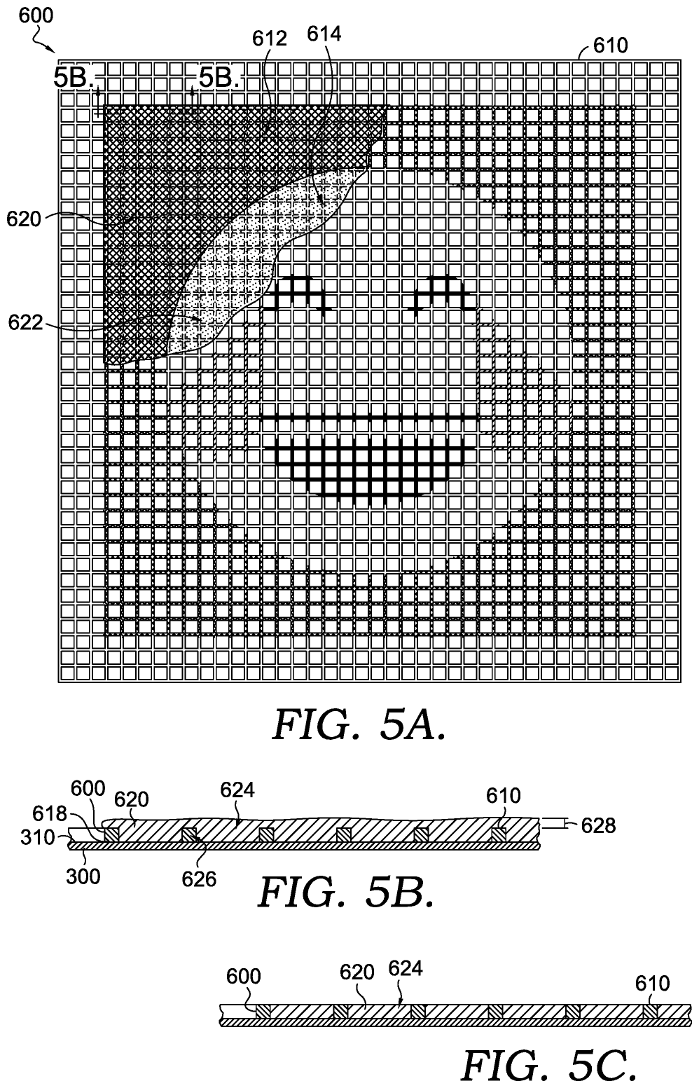

As discussed further below with respect to FIGS. 5A-5C, the leveler 500 can optionally be utilized to level and/or remove excess modeling compound from a modeling tool, e.g., the modeling tool 200. The leveler 500 can include any convenient tool for removing excess modeling compound during the formation of the pixelated modeling compound artwork, such as a spatula or the like.

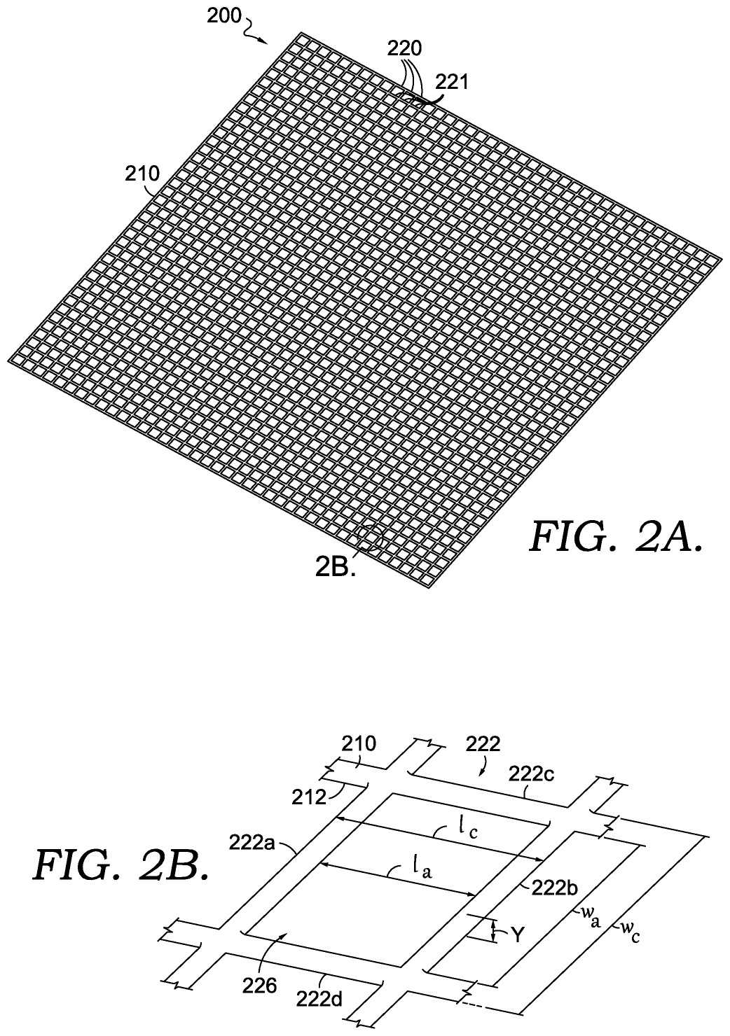

As discussed above, a modeling tool, e.g., the modeling tool 200, can be utilized to form or guide the formation of pixelated modeling compound artwork. The modeling tool 200 is discussed in detail further below with reference to FIGS. 2A-4.

In aspects, the system 100 can include the substrate 300, on which the modeling compound can be deposited during the formation of the artwork. In such aspects, modeling compound can be pressed through the modeling tool 200 and onto the modeling surface 310 of the substrate 300. Further, in such aspects, the substrate 300 can have a substantially similar surface area and/or substantially similar shape as the modeling tool 200. For example, as can be seen in the aspect depicted in FIG. 1, the modeling tool 200 and the substrate 300 exhibit a substantially similar shape, e.g., square-shaped. In the same or alternative aspects, the modeling tool 200 and/or the first surface 210 of the modeling tool 200 exhibits a width wₘ and a length lₘ that is substantially similar to the width wₛ and length lₛ, respectively, of the substrate 300 and/or the modeling surface 310. In such aspects, the modeling tool 200 and/or the first surface 210 of the modeling tool 200 can exhibit an area Aₘ (e.g., defined by the width wₘ and a length lₘ) that is substantially similar to an area Aₛ (e.g., defined by the width wₛ and length lₛ) of the substrate 300 and/or the modeling surface 310. In aspects, the area Aₛ of the substrate 300 and/or the modeling surface 310 can be equal to or greater than the area Aₘ of the modeling tool 200 and/or the first surface 210.

In certain aspects, the substrate 300 can be any material that is substantial enough to support the pixelated modeling compound artwork creation, and to withstand the tension from removal of the modeling tool 200 from the modeling surface 310 of the substrate 300. For example in aspects, the substrate 300 may comprise a cardboard and/or cardstock material that maintains rigidity and works well to receive modeling compound inserted through the modeling tool 200. In further aspects, the modeling surface 310 of the substrate 300 may include a matted surface or a textured surface, adapted to receive and maintain the modeling compound inserted through the modeling tool 200. As such, in aspects, a non-glossy modeling surface 310 may be utilized to facilitate receipt of each deposited volume of modeling compound, so that the deposited volumes may remain attached to the substrate 300 during creation of the artwork, and also remain coupled to the modeling surface 310 during removal of the modeling tool 200 and creation of the final artwork.

FIG. 2A depicts the modeling tool 200 and FIG. 2B depicts a close up view of a portion of the modeling tool 200 of FIG. 2A. The modeling tool 200 depicted in the figures is but one example modeling tool, and modifications and/or variations of the modeling tool are also contemplated by the disclosure herein.

As discussed above, in aspects, the modeling tool 200 can be utilized as a template for forming pixelated modeling compound artwork that includes individual deposited volumes of modeling compound. In such aspects, the modeling tool 200 can include a plurality of cells 220 to facilitate the formation of the individual deposited volumes of modeling compound. As best seen in FIG. 1B, the cell 222 is structured to define an aperture 226 that extends from the first surface 210 of the modeling tool 200 to an opposing second surface 212 of the modeling tool 200. In aspects, modeling compound can be pressed or inserted into one or more apertures and onto a substrate underneath, thereby forming deposited volumes of modeling compound.

In aspects, the cells and associated apertures can be in any shape or size. In certain aspects, modeling tool 200 can include cells and associated apertures that are substantially the same shape and/or size. For instance, as can be seen in the aspect depicted in FIG. 2A, the plurality of cells 220 and associated plurality of apertures 221 are substantially the same size and/or shape. In one aspect, the plurality of cells 220 and the associated apertures 221 can be of a uniform size and/or shape. In an aspect not depicted in the figures, a modeling tool can include a portion of cells and/or apertures of a first size and/or shape, and another portion of cells and/or apertures of a second size and/or shape, different from the first.

As best seen in FIG. 2B, the cell 222 has a length l_{c} extending from the side 222a to the side 222b, and a width w_{c} extending from the side 222c to the side 222d. In such aspects, the cell 222 can exhibit a cross-sectional area A_{c}, defined by the length l_{c} and the width w_{c}, of from 0.5 square millimeters (mm²) to 180 mm², 1 mm² to 160 mm², or 2 mm² to 140 mm². The cell 222 depicted in FIG. 2B also exhibits a depth Y extending from the first surface 210 to the second surface 212 of the modeling tool material. In aspects, the depth Y of the cell 222 be of from 0.3 mm to 10 mm, 0.4 mm to 5 mm, or 0.5 mm to 2 mm. In aspects, where the modeling tool material is cylindrically shaped, the depth Y can refer to the diameter of the modeling tool material. In aspects, the dimensions of the cell 222 may be the same or similar for each of the plurality of cells 220. In one aspect, the values of the cross-sectional area A_{c} of the cell 222 described herein can be an average cross-sectional area of the plurality of cells 220. In the same or alternative aspects, the values for the depth Y of the cell 222 described herein can be an average depth of the plurality of cells 220, or a minimum depth or minimum diameter.

In aspects, the cell 222 can define the dimensions of the aperture 226. For instance as noted above in aspects, the aperture 226 extends from the first surface 210 to the second surface 212 of the modeling tool material, and as such, exhibits a similar depth Y as the cell 222 described above. In the same or alternative aspects, the cross-sectional area Aₐ of the aperture 226 can be defined by the length lₐ extending in a direction between the side 222a to the side 222b, and a width wₐ extending in a direction between the side 222c to the side 222d. In such aspects, the cross-sectional area Aₐ of the aperture 226 can be of from 1 square mm² to 100 mm², 1.2 mm² to 90 mm², or 1.4 mm² to 85 mm². In one aspect, the values of the cross-sectional area Aₐ of the aperture 226 described herein can be an average cross-sectional area of the plurality of apertures 221.

As described above, the dimensions of the cell, e.g., the cell 222, define or determine the dimensions of the aperture, e.g., the aperture 226. In such aspects, the dimensions of the cell, e.g., the cell 222, can determine the dimensions of each “pixel” or deposited volume of the modeling compound in the pixelated modeling compound artwork. For example in aspects, the dimensions of each modeling compound “pixel” inserted into each cell aperture and deposited within the boundaries of each cell and against the substrate, is determined based on the size of the aperture. For example, in one aspect, the cells of a modeling tool, e.g., the modeling tool 200, may include square cells that define square apertures, which may be approximately 6 mm² and bordered by a cell material having a depth of 1 mm, giving the overall cell a depth of 1 mm and the aperture having a depth for receiving the modeling compound. Accordingly, in certain aspects, the modeling tool 200 may be used to generate “pixels” or deposited volumes of modeling compound that are approximately 2 mm×2 mm×0.6 mm or larger, or 4 mm×4 mm×0.7 mm or larger, or 6 mm×6 mm×1 mm or larger. It should be understood that these deposited volume values immediately described herein are just one set of example volumes of modeling compound contemplated by the disclosure herein.

In aspects, the modeling tool 200 and/or the plurality of cells 220 can be formed from any material that is capable of maintaining the shape and/or size of the plurality of cells 220 during the application of forces experienced in the formation of the pixelated modeling compound artwork. For instance, the modeling tool 200 and/or the plurality of cells 220 can be formed from any material that is adapted to maintain the shape and/or size of the plurality of cells 220 while the modeling compound in being pressed or inserted into the plurality of apertures 221, and while the modeling tool 200 is removed from contact with the substrate, leaving the deposited volumes of modeling compound behind on the substrate. In various aspects, the modeling tool 200 and/or the plurality of cells 220 can include a plastic material, a natural material, or a combination thereof. In the same or alternative aspects, the modeling tool 200 and/or the plurality of cells 220 can be a monofilament fiber or a multifilament fiber.

As discussed above, in aspects, a modeling tool, e.g., the modeling tool 200, can be utilized to specify the location where a specific modeling compound is to be deposited, e.g., inserted into one or more of the cell apertures. For instance, in various aspects, a modeling tool can include one or more characteristics that is associated with a specific modeling compound. In certain aspects, the one or more characteristics can include a coloration on a surface of the modeling tool, or various markings, including imprints, words, numbers, and the like on the surface of the modeling tool. In aspects, the one or more characteristics can be added to the modeling tool in any manner, e.g., by printing, or mechanical surface deformation of the modeling tool.

In certain aspects, the one or more characteristics present on the modeling tool can be associated with one or more cells present in the modeling tool. For instance, as discussed above, the modeling tool can include one or more characteristics that define specific distinct cells or portions of cells of the modeling tool, thereby providing an indication for a user to use modeling compounds having a distinct characteristic for each of the specific distinct cells of the modeling tool, resulting in an intended design.

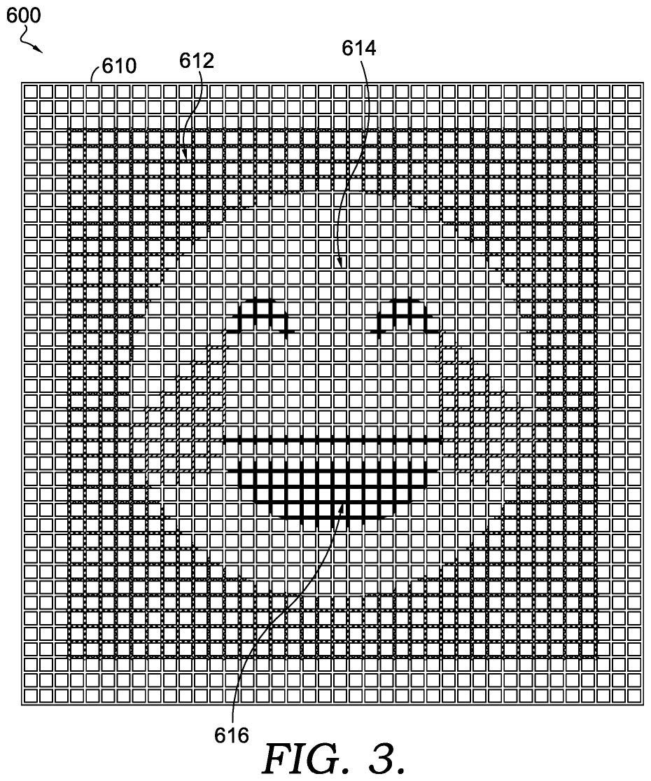

FIG. 3 depicts one example modeling tool 600 that includes various characteristics present on a first surface 610 of the modeling tool 600. For example in the aspect depicted in FIG. 3, the first surface 610 includes a portion of cells having a first characteristic 612, another portion of cells having a second characteristic 614, and yet another portion of cells having a third characteristic 616. As can be seen in the aspect depicted in FIG. 3, the distinct characteristics provided on the first surface 610 of the modeling tool 600 provide an indication of an intended design.

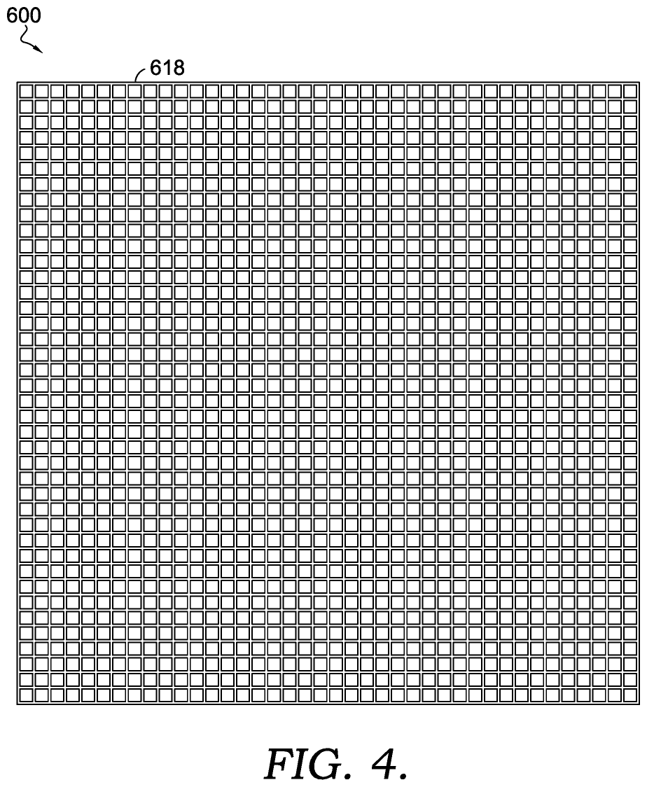

FIG. 4 depicts the second surface 618 that is opposite the first surface 610, of the modeling tool 600. As can be seen in comparing FIGS. 3 and 4, the first characteristic 612, the second characteristic 614, and the third characteristic 616 present on the first surface 610 are not visible and/or present on the second surface 618 of the modeling tool 600.

FIG. 5A depicts the modeling tool 600 with a portion of the cells having modeling compounds inserted into the apertures of the cells. For instance, a first modeling compound 620 having a first modeling compound characteristic has been pressed or inserted into a portion of the apertures of the cells having the first characteristic 612, and a second modeling compound 622 having a second modeling compound characteristic has been pressed or inserted into a portion of the apertures of the cells having the second characteristic 614. As discussed above, in certain aspects, the modeling compound characteristics can be a reference to distinct colors or other visually distinguishing characteristic.

FIG. 5B shows a cross-section along the cutline 5B in FIG. 5A. As can be seen in FIG. 5B, the modeling tool 600 is present on the substrate 300, i.e., in a modeling configuration, where the second surface 618 of the modeling tool 600 is contacting the modeling surface 310 of the substrate 300. As can be seen in FIG. 5B, the first modeling compound 620 is present in several apertures, e.g., the aperture 624 defined by the cell 626 of the modeling tool 600. In such an aspect, the first modeling compound 620 contacts the modeling surface 310 and the cell 626.

In certain aspects as discussed above, when pressing or inserting the modeling compound into one or more cells of a modeling tool, excess modeling compound may be present above the first or top surface of the modeling tool 600. For example, as can be seen in FIG. 5B an excess portion 628 of the first modeling compound 620 is present above the first surface 610 of the modeling tool 600. In such aspects, a leveler, e.g., the leveler 500 discussed above with reference to FIG. 1, may be utilized to remove the excess portion 628 of the first modeling compound 620. FIG. 5C depicts the cross-section of FIG. 5B after utilizing a leveler, e.g., the leveler 500, to remove the excess portion 628 of the first modeling compound 620 depicted in FIG. 5B. As can be seen in FIG. 5C, after the removal of the excess portion 628, the first modeling compound 620, while still present in the cells, e.g., the cell 626, is no longer extending out and above the first surface 610 of the modeling tool 600.

In some aspects, the adjoining modeling compounds that have been pressed into the modeling tool, e.g., the first modeling compound 620 and the second modeling compound 622 may appear to have blended at or near the first surface 610 of the modeling tool 600, e.g., which may be present in an excess portion, e.g., excess portion 628. However, in such aspects, after removal of the excess portion with a leveler, any cross-joined modeling compound may be removed, and the isolated pixels or deposited volumes of modeling compound may remain without blending various modeling compounds, or their colors or other visual characteristics, between adjacent pixels.

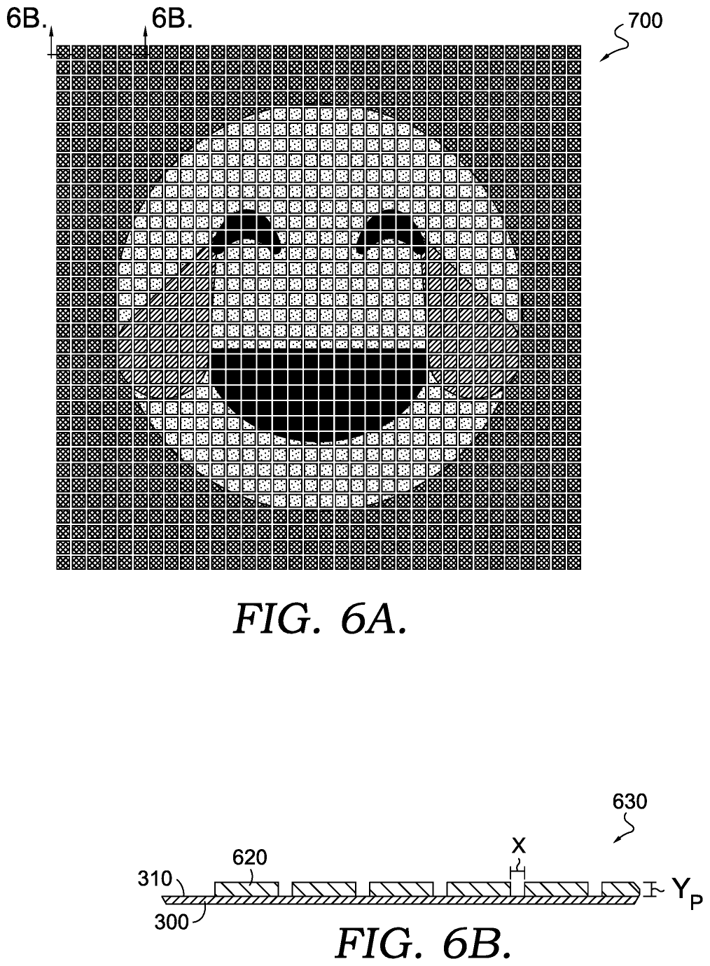

FIG. 6A depicts a pixelated modeling compound artwork piece 700 that was formed by filling in all of the cells of the modeling tool 600, e.g., with a distinct modeling compound for each of the distinct characteristics on the first surface 610 of the modeling tool 600 to form the intended design, which is depicted by the positioning of the characteristics on the first surface 610 of the modeling tool 600.

FIG. 6B depicts a cross-sectional view of the pixelated modeling compound artwork piece 700 along the cutline 6B. In such aspects, this display configuration, where the modeling tool 600 has been removed from the modeling surface 310 of the substrate 300, can leave a plurality of individual deposited volumes of modeling compound 630 or pixels positioned on the modeling surface 310 of the substrate 300, providing the pixelated modeling compound artwork piece 700.

In aspects, each of the plurality of individual deposited volumes of modeling compound 630 can be spaced apart from one another, e.g., due to the presence of the modeling tool 600 while inserting the modeling compounds into the modeling tool 600 and the subsequent removal of the modeling tool 600 when shifting from the modeling configuration to the display configuration. In such aspects, the plurality of individual deposited volumes of modeling compound 630 can be spaced apart from one another by a distance X, wherein X is the same or substantially similar to the diameter or depth of the modeling material forming the cells of the modeling tool 600. In aspects, the distance X can be the same or substantially similar to the depth Y of the cell 222 discussed above with respect to the modeling tool 200 of FIGS. 2A and 2B.

In aspects as discussed above, each of the plurality of individual deposited volumes of modeling compound 630 or pixels can exhibit the dimensions of the apertures from which they were formed. For instance, as discussed above, the depth Yₚ of each of the individual deposited volumes of modeling compound 630 can exhibit the depth of the apertures formed from the cells of the modeling tool 600. In such aspects, the depth Yₚ can be the same or substantially similar to the depth Y discussed above with respect to the cell 222 and the aperture 226 depicted in FIG. 2B. It should be understood that the specific ranges of dimensions of the individual deposited volumes of modeling compound 630 are just one example and that other sizes and shapes of deposited volumes of modeling compound in a pixelated modeling compound artwork are contemplated by the disclosure herein.

Further, it should be understood that in other aspects, a user may generate freestyle design using the systems described herein, e.g., with a “blank” modeling tool in the absence of characteristics thereon. Instead, in such aspect, the user can utilize the cell concept of the modeling tool, e.g, a pixel concept, along with variable colors of modeling compound to selectively color within each cell to develop a freestyle design.

The aspects described throughout this specification are intended in all respects to be illustrative rather than restrictive. Upon reading the present disclosure, alternative aspects will become apparent to ordinary skilled artisans that practice in areas relevant to the described aspects without departing from the scope of this disclosure. In addition, aspects of this technology are adapted to achieve certain features and possible advantages set forth throughout this disclosure, together with other advantages which are inherent. It will be understood that certain features and subcombinations are of utility and may be employed without reference to other features and subcombinations. This is contemplated by and is within the scope of the claims.

Since many possible embodiments may be made of the technology described herein without departing from the scope thereof, it is to be understood that all matter herein set forth or shown in the accompanying drawings is to be interpreted as illustrative and not in a limiting sense. Alternatively, the aspects described throughout this specification are intended in all respects to be illustrative rather than restrictive. Upon reading the present disclosure, alternative aspects will become apparent to ordinary skilled artisans that practice in areas relevant to the described aspects without departing from the scope of this disclosure. In addition, aspects of this technology are adapted to achieve certain features and possible advantages set forth throughout this disclosure, together with other advantages which are inherent. It will be understood that certain features and subcombinations are of utility and may be employed without reference to other features and subcombinations. This is contemplated by and is within the scope of the claims.

The invention claimed is:

1. A kit for generating pixelated modeling compound artwork, wherein the kit comprises:
a modeling tool having a first surface and an opposing second surface, the modeling tool comprising a plurality of cells, each of the plurality of cells having an aperture extending from the first surface to the second surface, wherein the plurality of cells exhibit a plurality of characteristics; and
a plurality of modeling compounds, each of the plurality of modeling compounds separable into a plurality of segments.

2. The kit according to claim 1, further comprising a substrate, the substrate comprising a modeling surface having an area Aₛ, wherein the modeling tool first surface has an area Aₘ, wherein the area Aₛ is equal to or greater than the area Aₘ.

3. The kit according to claim 1, wherein the plurality of cells is comprised of a monofilament fiber or a multifilament fiber.

4. The kit according to claim 3, wherein the monofilament fiber or the multifilament fiber comprises a plastic material, a natural material, or a combination thereof.

5. The kit according to claim 3, wherein the monofilament fiber or the multifilament fiber exhibits a minimum diameter of from 0.3 millimeters (mm) to 10 mm.

6. The kit according to claim 1, wherein the aperture of each of the plurality of cells exhibits substantially the same cross-sectional area, substantially the same shape, or both.

7. The kit according to claim 1, wherein the aperture of each of the plurality of cells exhibits a cross-sectional area of from 1 square millimeter (mm²) to 100 mm².

8. The kit according to claim 2, wherein the substrate comprises a cardboard material, a cardstock material, or a combination thereof.

9. The kit according to claim 1, wherein the plurality of characteristics are present on at least the first surface of the modeling tool.

10. The kit according to claim 9, wherein each of the plurality of modeling compounds exhibits a distinct coloration, wherein each of the plurality of characteristics of the plurality of cells corresponds with one of the plurality of modeling compounds so that when the plurality of modeling compounds are molded in respective apertures of the plurality of cells an intended design is formed.

11. A pixelated modeling compound artwork system comprising:
a modeling tool having a first surface and an opposing second surface, the modeling tool comprising a plurality of cells, each of the plurality of cells having an aperture extending from the first surface to the second surface, wherein a first portion of the plurality of cells exhibits a first cell characteristic on the first surface, and wherein a second portion of the plurality of cells exhibits a second cell characteristic on the first surface;
a first modeling compound having a first modeling compound characteristic corresponding to the first cell characteristic;
a second modeling compound having a second modeling compound characteristic corresponding to the second cell characteristic; and
a substrate comprising a modeling surface having an area Aₛ, wherein the first surface of the modeling tool has an area Aₘ, wherein the area Aₛ is equal to or greater than the area Aₘ,
wherein the substrate and the modeling tool are cooperatively adapted to receive on the modeling surface a plurality of deposited volumes of the first and second modeling compounds to form an intended design, and wherein each of the plurality of deposited volumes correspond to individual cells of the plurality of cells.

12. The system according to claim 11, wherein the aperture of each of the plurality of cells exhibits substantially the same cross-sectional area, substantially the same shape, or both.

13. The system according to claim 12, wherein the aperture of each of the plurality of cells exhibits a cross-sectional area of from 1 square millimeter (mm²) to 100 mm².

14. The system according to claim 11, wherein the plurality of cells is comprised of a monofilament fiber or a multifilament fiber, and wherein the monofilament fiber or the multifilament fiber exhibits a minimum diameter of from 0.3 millimeters (mm) to 10 mm.

15. The system according to claim 11, wherein the first cell characteristic and the second cell characteristic are a first coloration and a second coloration, respectively, and wherein the first coloration is distinct from the second coloration.

16. A pixelated modeling compound artwork device, comprising:
a modeling tool having a first surface and an opposing second surface, the modeling tool comprising a plurality of cells, each of the plurality of cells having an aperture extending from the first surface to the second surface, wherein the plurality of cells exhibit a plurality of characteristics;
a substrate comprising a modeling surface having an area Aₛ, wherein the first surface of the modeling tool has an area Aₘ, wherein the area Aₛ is equal to or greater than the area Aₘ; and
a plurality of modeling compounds, each of the plurality of modeling compounds separable into a plurality of segments,
wherein the modeling tool and the substrate are adapted to be shifted from: 1) a modeling configuration where the modeling tool is positioned on the substrate so that the second surface of the modeling tool contacts the modeling surface of the substrate; and 2) a display configuration where the modeling tool is removed from the substrate so that the second surface of the modeling tool no longer contacts the modeling surface of the substrate.

17. The device according to claim 16, wherein the modeling tool and the substrate are cooperatively adapted to, when in the modeling configuration, receive on the modeling surface a plurality of deposited volumes of the plurality of modeling compounds to form an intended design indicated by the plurality of characteristics, and wherein when shifting from the modeling configuration to the display configuration, the modeling tool and the substrate are cooperatively adapted to retain on the modeling surface the plurality of deposited volumes of the plurality of modeling compounds.

18. The device according to claim 16, wherein the aperture of each of the plurality of cells exhibits substantially the same cross-sectional area, substantially the same shape, or both.

19. The device according to claim 16, wherein the plurality of cells is comprised of a monofilament fiber or a multifilament fiber, and wherein the monofilament fiber or the multifilament fiber exhibits a minimum diameter of from 0.3 millimeters (mm) to 10 mm.

20. The device according to claim 16, wherein each of the plurality of modeling compounds exhibits a distinct coloration.
